(19) United States
(12) Patent Application Publication
(10) Pub. No.: US 2017/0290490 A1
(43) Pub. Date: Oct. 12, 2017

(54) CLEANING TOOL AND CLEANING ROBOT

(71) Applicant: SHARP KABUSHIKI KAISHA, Osaka (JP)

(72) Inventors: SHUNPEI YAMANAKA, Osaka (JP); GO MORI, Osaka (JP)

(73) Assignee: SHARP KABUSHIKI KAISHA, Osaka (JP)

(21) Appl. No.: 15/455,134

(22) Filed: Mar. 10, 2017

(30) Foreign Application Priority Data
Apr. 12, 2016 (JP) 2016-079868

(51) Int. Cl. A47L 25/00; A47L 11/40; B08B 7/00

(52) U.S. Cl. CPC A47L 25/005; B08B 7/0028; A47L 11/4036; A47L 2201/00

(57) ABSTRACT

A cleaning tool includes: an adhesive portion that adsorbs an object to be adsorbed and a film portion that includes the adhesive portion. The film portion includes a hole portion which expands in accordance with an external force applied to the film portion. The adhesive portion is exposed to the outside of the film portion via the hole portion in a case where the external force equal to or greater than a predetermined magnitude is applied to the film portion.

### BACKGROUND

### 1. Field

The present disclosure relates to a cleaning tool which is used in cleaning.

### 2. Description of the Related Art

A cleaning tool for removing trash (an object to be adsorbed and an object to be cleaned) including dust or dirt from a surface to be cleaned (for example, a floor or a desk) is described, for example, in Japanese Patent No. 3621197 (published on Feb. 16, 2005), Japanese Unexamined Patent Application Publication No. 11-137504 (published on May 25, 1999), Japanese Unexamined Patent Application Publication No. 2014-64833 (published on Apr. 17, 2014), Japanese Unexamined Patent Application Publication No. 10-179498 (published on Jul. 7, 1998), Japanese Unexamined Patent Application Publication No. 2000-41935 (published on Feb. 15, 2000), and Japanese Unexamined Patent Application Publication No. 2010-58040 (published on Mar. 18, 2010).

Japanese Patent No. 3621197 describes a cleaning tool including cleaning cloth, a head portion to which the cleaning cloth is attached, and a handle. In the cleaning tool, the cleaning cloth is attached to the head portion, and a recess portion is provided on a cleaning surface side of the head. An adhesive member is disposed in the recess portion, and an opening portion from which the adhesive member is exposed is provided in the cleaning cloth. When performing the cleaning, fine trash is captured by entanglement or the like of fibers of the cleaning cloth, and coarse trash is captured by the adhesive member.

Japanese Unexamined Patent Application Publication No. 11-137504 describes a cleaning apparatus which automatically performs cleaning by causing a polymer gel to be in contact with, for example, a floor surface, and by causing trash or the like on the floor to adhere to the gel. In addition, the cleaning apparatus includes a circulation portion for circulating the gel and is configured so that a clean part of the gel comes into contact with the floor.

Japanese Unexamined Patent Application Publication No. 2014-64833 describes a rotary adhesive cleaner in which an adhesive film layer is formed on an outer circumferential surface of a roller material. By pressing the rotary adhesive cleaner to a cleaning target, dust or stain which is attached to a surface of the cleaning target adheres and moves to the adhesive film layer.

Japanese Unexamined Patent Application Publication No. 10-179498 describes an adhesive cleaning sheet in which a base layer containing a fungi-removing component is provided on a support sheet. The base layer contains a hydrophilic adhesive material for allowing the base layer to adhere to a portion to be cleaned.

Japanese Unexamined Patent Application Publication No. 2000-41935 describes an adhesive cleaning sheet which includes a support sheet, a fungi-removing component, and a water-soluble sheet. The water-soluble sheet realizes adhesiveness by being hydrated or/and being dissolved in water. The adhesive cleaning sheet adheres to a portion to be cleaned via the water-soluble sheet and water.

Japanese Unexamined Patent Application Publication No. 2010-58040 describes a cleaning film having an adhesive material layer on a support body. The adhesive material layer contains swelling gel, and in a case where a foreign material on a surface of a base having fine unevenness is removed, the foreign material may be removed by following the fine unevenness.

An example of the related art includes Mariam Mir, Murtaza Najabat Ali, Javaria Sami, and Umar Ansari, “Review of Mechanics and Applications of Auxetic Structures”, Hindawi Publishing Corporation Advances in Materials Science and Engineering Volume 2014.

However, in any of the related art described in Japanese Patent Application No. 3621197, Japanese Unexamined Patent Application Publication No. 2014-64833, Japanese Unexamined Patent Application Publication No. 10-179498, Japanese Unexamined Patent Application Publication No. 2000-41935, and Japanese Unexamined Patent Application Publication No. 2010-58040, an adsorbed object is maintained in a state of being exposed after finishing the cleaning, and thus, there are insufficient sanitary conditions. In addition, the cleaning apparatus described in Japanese Unexamined Patent Application Publication No. 11-137504 has the circulation portion which circulates the passing gel as described above. However, since the adsorbed matter which circulates together with the gel is considered to be exposed on a surface other than a surface that comes into contact with the floor of the gel, there is a problem of insanitary conditions.

### SUMMARY

It is desirable to realize a cleaning tool which is excellent in sanitary conditions as compared to a cleaning tool of the related art.

A cleaning tool according to an aspect of the disclosure includes: an adhesive portion that adsorbs an object to be adsorbed; and a film portion that includes the adhesive portion. The film portion includes a hole portion which expands in accordance with an external force applied to the film portion, and the adhesive portion is exposed to the outside of the film portion via the hole portion in a case where an external force equal to or greater than a predetermined magnitude is applied to the film portion.

### BRIEF DESCRIPTION OF THE DRAWINGS

FIG. 1A is a sectional view illustrating a configuration of a cleaning tool according to Embodiment 1, FIG. 1B is a sectional view illustrating a state where a pressure is applied to the cleaning tool illustrated in FIG. 1A, FIG. 1C is an enlarged view of a region indicated by a dotted line in FIG. 1A, and FIG. 1D is an enlarged view of a region indicated by a dotted line in FIG. 1B;

FIG. 2A is a sectional view illustrating a configuration of a cleaning tool according to a modification example of Embodiment 1, and FIG. 2B is a sectional view illustrating a cleaning tool illustrated in FIG. 2A in a state where tension is applied to the film portion by a tension applying portion;

FIG. 3A is a sectional view illustrating a configuration of a cleaning tool according to Embodiment 2, and FIG. 3B is a view illustrating Poisson's ratio;

FIGS. 4A to 4D are views respectively illustrating an operation of the cleaning tool according to Embodiment 2;

FIG. 5A is a sectional view illustrating a configuration of a cleaning tool according to Embodiment 3, FIG. 5B is an enlarged view of a region indicated by a dotted line in FIG. 5A in a case where a pressure is not applied to a mesh portion, FIG. 5C is a view illustrating a lower surface of the mesh portion in a case where the pressure is not applied to the mesh portion, FIG. 5D is an enlarged view of a region indicated by a dotted line in FIG. 5A in a case where the pressure is applied to the mesh portion, and FIG. 5E is a view illustrating the lower surface of the mesh portion in a case where the pressure is applied to mesh portion;

FIG. 6A is a sectional view illustrating a configuration of a cleaning tool according to Embodiment 4, FIG. 6B is a view illustrating the cleaning tool in a state where a pressure is applied to the mesh portion, FIG. 6C is an enlarged view of a region A indicated by a broken line in FIG. 6B, FIG. 6D is an enlarged view of a region B indicated by a broken line in FIG. 6B, and FIG. 6E is a view illustrating movement of an adhesive portion and the film portion inside of the mesh portion;

FIG. 7A is a sectional view illustrating a configuration of a cleaning tool according to Embodiment 5, FIG. 7B is a view illustrating the cleaning tool in a state where the pressure is applied by a pressure applying portion, FIG. 7C is a view illustrating a state of the cleaning tool after the cleaning tool is used in cleaning, and FIG. 7D is a view illustrating a state where the adhesive portion of an outermost layer is removed from the cleaning tool illustrated in FIG. 7C;

FIG. 8A is a sectional view illustrating a configuration of a cleaning tool according to Embodiment 6, FIG. 8B is a sectional view illustrating a state where the pressure is applied to the film portion, FIG. 8C is an enlarged view of a region surrounded by a dotted line in FIG. 8A, and FIG. 8D is an enlarged view of a region surrounded by a dotted line in FIG. 8B;

FIG. 9A is a sectional view illustrating a configuration of a cleaning tool according to Embodiment 7, FIG. 9B is a sectional view illustrating a state where the pressure is applied to the film portion, FIG. 9C is an enlarged view of a region surrounded by a dotted line in FIG. 9A, and FIG. 9D is an enlarged view of a region surrounded by a dotted line in FIG. 9B;

FIGS. 10A to 10D are views illustrating a configuration of portions of a cleaning robot according to Embodiment 8, FIG. 10A is a view schematically illustrating an appearance of the cleaning robot, FIG. 10B is a top view of the cleaning robot, FIG. 10C is a side view of the cleaning robot, and FIG. 10D is a sectional view taken along line XD-XD of FIG. 10C; and

FIGS. 11A and 11B are partial sectional views illustrating an example of cleaning by the cleaning robot according to Embodiment 8, FIG. 11A is a view illustrating a state before the pressure is applied to the cleaning tool, and FIG. 11B is a view illustrating a state after the pressure is applied to the cleaning tool.

### DESCRIPTION OF THE EMBODIMENTS

### Embodiment 1

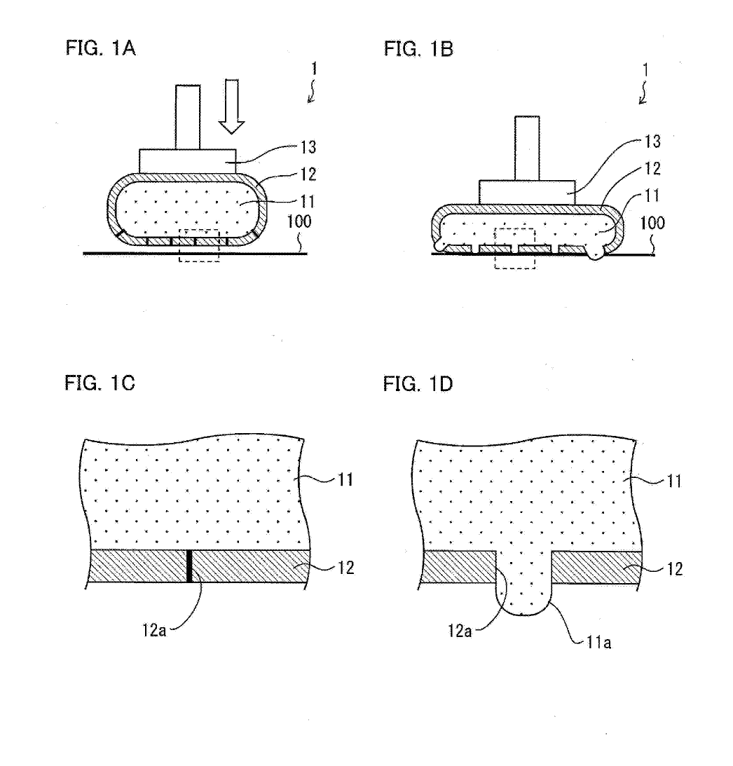

Embodiment 1 of the disclosure will be described based on FIGS. 1A to 1D, and is as follows. First, a configuration of a cleaning tool 1 of the embodiment will be described with reference to FIG. 1A. FIG. 1A is a sectional view illustrating a configuration of the cleaning tool 1.

As will be described hereinafter, the cleaning tool 1 may be a tool (handy cleaner) for a user to manually clean a surface to be cleaned 100 (for example, a floor or a desk).

### Configuration of Cleaning Tool 1

The cleaning tool 1 includes an adhesive portion 11, a film portion 12, and a pressure applying portion 13. The adhesive portion 11 is a member which adsorbs trash (object to be adsorbed), such as dust or dirt, which exists on the surface to be cleaned 100. The adhesive portion 11 is configured of a material having incompressibility (properties that density does not change before and after deformation), and having high stickiness (instantaneously adhesiveness) on a surface thereof.

Specific examples of a material of the adhesive portion 11 include a polymer material, such as elastomer or gel (hydrogel, xerogel, or organogel), polyvinyl alcohol (PVA), an acrylic resin, a urethane resin, or a silicone resin. In addition, as a material of the adhesive portion 11, a general rubber material can also be used.

The film portion 12 is a film-like member including the adhesive portion 11. The film portion 12 is configured of a material having flexibility. A material of the film portion 12 is a general polymer material, and for example, a polymer material such as elastomer or gel, PVA, an acrylic resin, a urethane resin, or a silicone resin, which is described above as a material of the adhesive portion 11, may be employed.

In addition, as the material of the film portion 12, a polymer material, such as polytetrafluoroethylene (PTFE), polyethylene, or polyethylene terephthalate (PET), which is generally used and does not have adhesiveness may be used.

In addition, in the film portion 12, a hole portion 12a which expands in accordance with a pressure (external force) applied to the film portion 12 is formed in advance (refer to FIGS. 1C and 1D which will be described later). In a case where the pressure equal to or greater than a predetermined magnitude is applied to the film portion 12, the hole portion 12a expands to have a size that causes the adhesive portion 11 to be exposed to the outside of the film portion 12.

In addition, the film portion 12 has high sliding properties on the surface thereof (coefficient of friction is small). Therefore, the adhesive portion 11 does not adhere to the film portion 12. In addition, the adhesive portion 11 may further contain a detergent component.

As described above, the adhesive portion 11 is formed of a material, such as rubber, gel, or elastomer. Therefore, the adhesive portion 11 has a wide elastic region. Therefore, even in a case where a comparatively high pressure (external force) is applied to the adhesive portion 11, performant distortion is not generated. Accordingly, even when large deformation is temporarily generated due to the pressure applied, the adhesive portion 11 returns to an original shape in a case where the pressure is removed.

In this manner, the adhesive portion 11 has self-recovering properties with respect to the pressure (external force). It is also possible to impart the above-described self-recovering properties to the adhesive portion 11 by using a hyperelastic material as the material of the adhesive portion 11.

The film portion 12 may not have the above-described self-recovering properties. In a case where the film portion 12 is deformed, for example, by applying the external force in a direction that is different from that of the pressure, the shape of the film portion 12 may be restored. In addition, following a self-recovering force of the adhesive portion 11, the shape of the film portion 12 may be restored. However, the above-described self-recovering properties may also be imparted to the film portion 12.

The pressure applying portion 13 is a member for applying the pressure to the adhesive portion 11 and the film portion 12 by the user who grips the pressure applying portion 13 and uses the cleaning tool 1. A manual operation of the pressure applying portion 13 can be performed by the user. The pressure applying portion 13 is in contact with a part of the film portion 12. Here, in the film portion 12, a side which opposes the surface to be cleaned 100 is a lower side, and a side opposite the lower side is an upper side. Hereinafter, the description will be given by referring to the upward-and-downward direction.

In the cleaning tool 1, the pressure applying portion 13 is in contact with an upper surface of the film portion 12. By applying the pressure in the downward direction to a lower surface of the film portion 12 by the pressure applying portion 13, a compression force which compresses the film portion 12 in the upward-and-downward direction is generated. In addition, in accordance with generation of the compression force, tension which expands the film portion 12 in the circumferential direction is generated.

### Operation of Cleaning Tool 1

Next, an operation of the cleaning tool 1 will be further described with reference to FIGS. 1B to 1D. FIG. 1B is a sectional view illustrating a state where the pressure is applied to the cleaning tool 1. FIG. 1C is an enlarged view of a region surrounded by a dotted line in the above-described FIG. 1A. FIG. 1D is an enlarged view of a region surrounded by a dotted line in FIG. 1B.

A white arrow in FIG. 1A indicates a direction (pressure applying direction) in which the pressure is applied to the film portion 12 from the pressure applying portion 13 when the cleaning tool 1 is being used. In FIGS. 1A to 1D, a case where the pressure applying direction is the downward direction is illustrated as an example.

In the cleaning tool 1 in a state illustrated in FIGS. 1A and 1C, when the user presses the pressure applying portion 13 and applies the pressure in the downward direction to the film portion 12 from the pressure applying portion 13, the pressure is transmitted to the film portion 12 and the adhesive portion 11 included in the film portion 12. As a result, the compression force in the downward direction and the tension in the circumferential direction act on each of the film portion 12 and the adhesive portion 11.

In addition, by the compression force and the tension, as illustrated in FIGS. 1B and 1D, the adhesive portion 11 and the film portion 12 are deformed. At this time, when the film portion 12 extends in the circumferential direction by the tension (stress), the hole portion 12a of the film portion 12 expands simultaneously.

In addition, by the expansion of the hole portion 12a, a part of the adhesive portion 11 protrudes (leaks) from the hole portion 12a, and the protruding portion 11a is formed. As a protruding portion 11a comes into contact with trash on the surface to be cleaned 100, the trash is adsorbed to the protruding portion 11a.

When the user stops pressing the pressure applying portion 13 (or reducing a pressing force), the pressure applied to the film portion 12 from the pressure applying portion 13 is released (or reduced). As a result, the cleaning tool 1 returns to a state illustrated in FIGS. 1A and 1C. This is because the adhesive portion 11 and the film portion 12 have shape memory properties as described above. At this time, the protruding portion 11a is included in the film portion 12 (reintroduced to the inside of the film portion 12) while maintaining a state where the trash is adsorbed. As the hole portion 12a contracts, the trash is blocked from the outside.

### Effect of Cleaning Tool 1

According to the cleaning tool 1 of the embodiment, in a case where the user cleans trash, it is possible to adsorb the trash to the protruding portion 11a by manually applying a large pressure to the film portion 12 by the pressure applying portion 13 and by causing a part (protruding portion 11a) of the adhesive portion 11 to protrude to the outside of the film portion 12. After finishing the cleaning, the user reduces the pressure applied to the film portion 12, and the protruding portion 11a which adsorbs the trash can return (be confined) to the inside of the film portion 12.

Therefore, in the cleaning tool 1, the trash adsorbed to the adhesive portion 11 is not exposed to the outside of the film portion 12 after finishing the cleaning. Accordingly, compared to a cleaning tool of the related art, the cleaning tool 1 becomes a cleaning tool which is excellent in sanitation.

In the embodiment, a configuration of the pressure applying portion 13 by which the user manually applies the pressure (external force) is illustrated as an example. However, the configuration of the pressure applying portion 13 is not limited thereto. For example, in a case where the cleaning tool 1 is provided in a cleaning robot, the pressure applying portion 13 may be configured to apply the pressure by the cleaning robot. This point is also similar in a tension applying portion 13A which will be described hereinafter.

### Modification Example

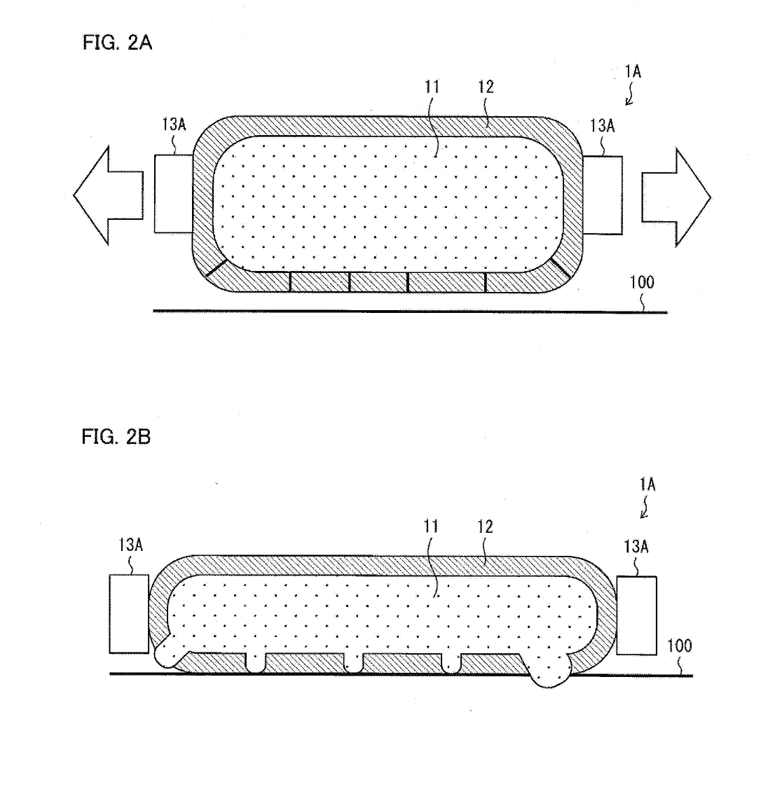

Next, a modification example of Embodiment 1 will be described based on FIGS. 2A and 2B. FIG. 2A is a sectional view illustrating a configuration of a cleaning tool 1A which is a modification example of the above-described cleaning tool 1. The cleaning tool 1A is provided with the tension applying portion 13A instead of the pressure applying portion 13 in the configuration of the cleaning tool 1.

The tension applying portion 13A is provided at two positions opposite each other in a circumferential edge portion of the film portion 12. As indicated by a white arrow in FIG. 2A, the respective tension applying portions 13A apply the tension (pulling force) in the directions opposite each other to the film portion 12. In addition, the tension is also applied to the adhesive portion 11 via the film portion 12.

FIG. 2B is a sectional view illustrating the cleaning tool 1A in a state where the tension is applied to the film portion 12 by the tension applying portion 13A. As illustrated in FIG. 2B, the film portion 12 to which the tension is applied by the tension applying portion 13A extends similarly to the film portion 12 to which the pressure is applied by the pressure applying portion 13, and the hole portion 12a extends. A part of the adhesive portion 11 leaks from the expanded hole portion 12a, and trash on the surface to be cleaned 100 can be adsorbed. When removing the tension, the adhesive portion 11 which adsorbs the trash returns to the original shape, and is included in the film portion 12.

By the above-described cleaning tool 1A, the trash adsorbed to the adhesive portion 11 is also accommodated inside of the film portion 12 after the cleaning is finished, and is not exposed to the outside. Therefore, similarly to the cleaning tool 1, the cleaning tool 1A becomes a cleaning tool which is excellent in sanitation.

As described above, the external force for exposing the adhesive portion 11 to the outside of the film portion 12 is not limited to the pressure, and may be the tension. In other words, in the cleaning tool according to one aspect of the disclosure, an external force applying portion for applying the above-described external force may be provided.

### Embodiment 2

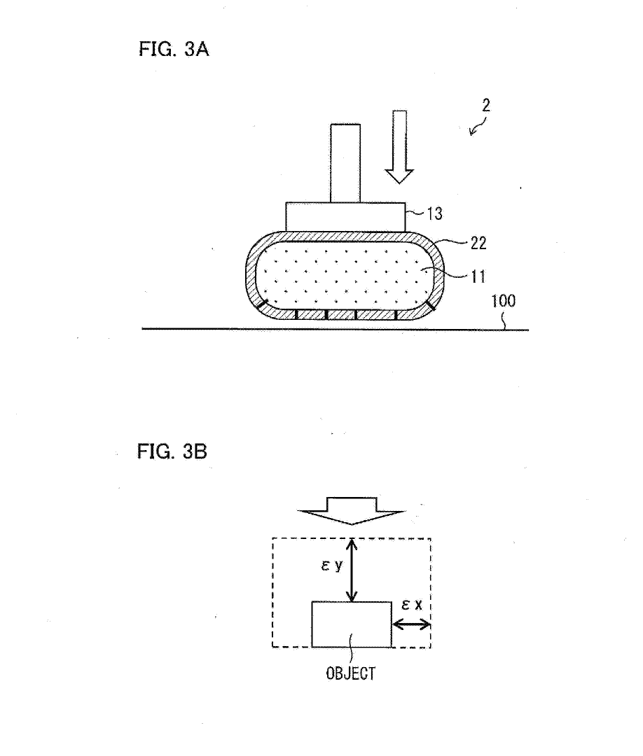

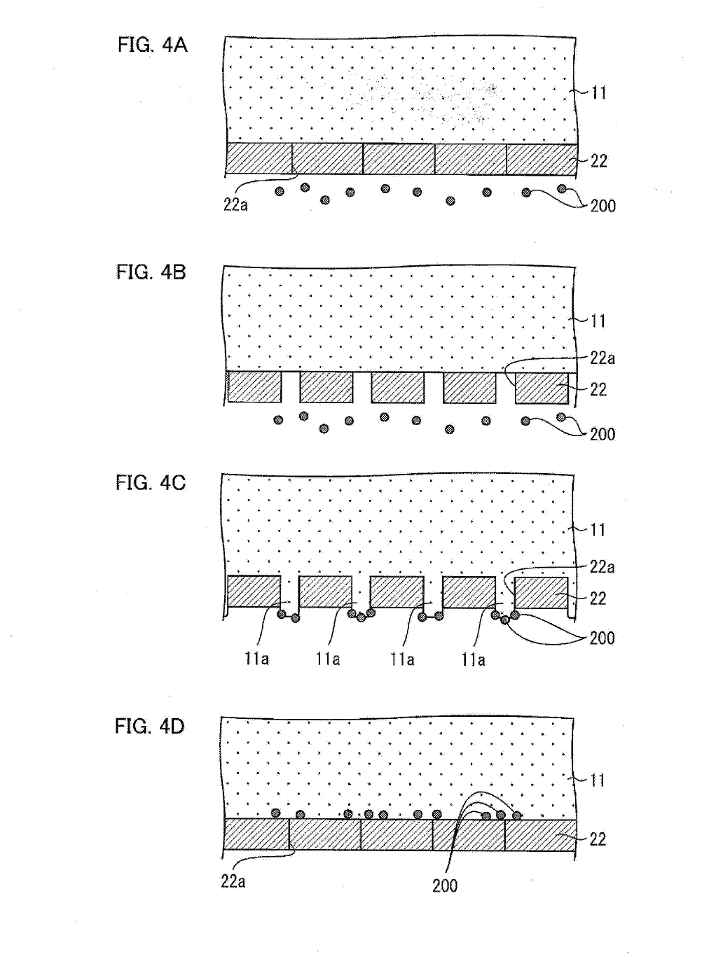

Embodiment 2 of the disclosure will be described based on FIGS. 3 and 4, and is as follows. For convenience of description, members having the same functions as those of the member described in the above-described embodiment will be given the same reference numerals, and the description thereof will be omitted.

### Configuration of Cleaning Tool 2

FIG. 3A is a sectional view illustrating a configuration of a cleaning tool 2 of the embodiment. The cleaning tool 2 is provided with a film portion 22 instead of the film portion 12 in the configuration of the cleaning tool 1. The film portion 22 is different from the film portion 12 in being configured of a material (auxetic material) having auxetic properties, and is similar to the film portion 12 in other parts.

The auxetic material means a material of which Poisson's ratio is negative. In addition, the auxetic properties mean properties having a negative Poisson's ratio.

FIG. 3B is a view illustrating the Poisson's ratio. In FIG. 3B, each of εx and εy is distortions in the x direction and in the y direction in an object. In the following description, regarding the distortion of the object, distortion in the direction in which the object expands (swells) is positive, and distortion in the direction in which the object contracts is negative. Here, the y direction is, for example, the above-described upward-and-downward direction. In addition, the x direction is the direction perpendicular to the y direction. In a case where the y direction is the contracting and pulling direction, the x direction is the shearing direction.

The Poisson's ratio ν is expressed as ν=−εx/εy. In a case of a material (non-auxetic material) which does not have auxetic properties, ν is positive. Therefore, εx and εy are of the opposite signs. For example, in a case where εy is negative, εx is positive. In other words, in a case where the object configured of the non-auxetic material is compressed in the y direction (refer to a white arrow in FIG. 3B), the object expands in the x direction.

Meanwhile, in a case of the auxetic material, ν is negative. Therefore, εx and εy are of the same sign. For example, in a case where εy is negative, εx is negative. In other words, in a case where the object configured of the auxetic material is compressed in the y direction, the object is also compressed in the x direction.

Specific examples of the auxetic material include extending PTFE, high-density polyethylene, urethane, or graphene. In addition, the auxetic properties are properties which can be imparted by forming a predetermined geometric structure inside of the material. Therefore, regarding a material other than the above-described materials, by forming a predetermined geometric structure such as a honeycomb structure or a chiral structure, it is also possible to impart auxetic properties. A specific example of the geometric structure is described in the above-described Mariam Mir, Murtaza Najabat Ali, Javaria Sami, and Umar Ansari, “Review of Mechanics and Applications of Auxetic Structures”, Hindawi Publishing Corporation Advances in Materials Science and Engineering Volume 2014.

### Operation of Cleaning Tool 2

FIGS. 4A to 4D are views respectively illustrating an operation of the cleaning tool 2. For convenience of understanding, in FIGS. 4A and 4B, trash 200 (object to be adsorbed) and the film portion 22 are separated from each other, but practically, the trash 200 and the film portion 22 are in contact with each other. In addition, the hole portion of the film portion 22 is referred to as a hole portion 22a.

First, as illustrated in FIG. 4A, the cleaning tool 2 is positioned over the trash 200 on the surface to be cleaned 100 (refer to FIG. 3A and other figures). In this state, when a downward pressure is applied to the film portion 22, as illustrated in FIG. 4B, the hole portion 22a expands. As described above, since the film portion 22 has auxetic properties, by compressing the film portion 22 in the upward-and-downward direction by the pressure applied with the pressure applying portion 13, the film portion 22 contracts in the direction parallel to the surface to be cleaned 100. Therefore, compared to the above-described hole portion 12a, an opening area of the hole portion 22a increases.

In addition, as illustrated in FIG. 4C, the adhesive portion 11 protrudes from the hole portion 22a, the protruding portion 11a is formed, and the trash 200 is adsorbed by the protruding portion 11a. After that, the pressure applied by the pressure applying portion 13 is removed, and as illustrated in FIG. 4D, the trash 200 adsorbed to the protruding portion 11a is accommodated inside of the film portion 22, and the hole portion 22a is closed. Therefore, the trash 200 can be held inside of the cleaning tool 2 without being exposed to the outside.

### Effect of Cleaning Tool 2

As described above, the film portion 22 of the cleaning tool 2 has auxetic properties. Therefore, in a case where the pressure is applied by the pressure applying portion 13, an opening area of the hole portion 22a is increased to be greater than the opening area of the hole portion 12a in the above-described cleaning tool 1. Therefore, according to the cleaning tool 2, since the adhesive portion 11 is caused to protrude to the outside more efficiently when the pressure is applied, it becomes possible to more efficiently perform the cleaning.

In addition, since it is possible to further increase the opening area of the hole portion 22a to be greater than the opening area of the hole portion 12a, an upper limit of the size of the trash which can be accommodated inside of the film portion 22 becomes greater than an upper limit of the size of the trash which can be accommodated inside of the film portion 12. Therefore, since the cleaning tool 2 can collect the trash which is larger than that collected by the cleaning tool 1, it is possible to use the cleaning tool 2 with respect to more types of trash (object to be adsorbed) than those collected by the cleaning tool 1.

### Embodiment 3

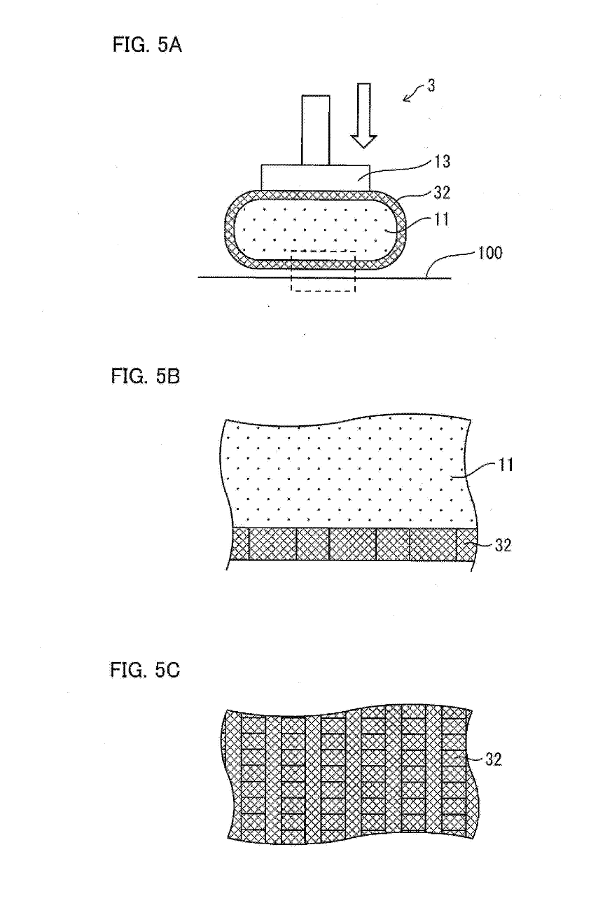

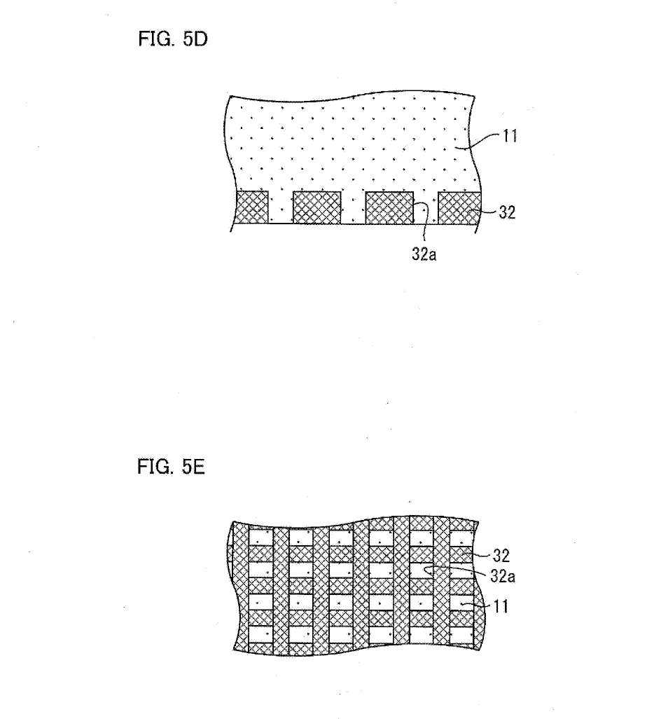

Embodiment 3 of the disclosure will be described based on FIGS. 5A to 5E, and is as follows.

### Configuration of Cleaning Tool 3

FIG. 5A is a sectional view illustrating a configuration of a cleaning tool 3 of the embodiment. As illustrated in FIG. 5A, the cleaning tool 3 has a mesh portion 32 instead of the film portion 12 in the configuration of the cleaning tool 1.

The mesh portion 32 is a member which accommodates the adhesive portion 11 inside thereof. The mesh portion 32 has a mesh-like structure which is knitted by an organic or a metal fiber which demonstrates elastic deformation. The organic material may be similar to the above-described material of the film portion 12. In addition, specific examples of the metal material include aluminum, alloy of aluminum, copper, copper alloy such as brass, nickel, titanium, or alloy of titanium or nickel, or alloy containing ferromanganese.

FIG. 5B is an enlarged view of a region indicated by a dotted line in FIG. 5A in a case where the pressure is not applied to the mesh portion 32. FIG. 5C is a view illustrating a lower surface of the mesh portion 32 in a case where the pressure is not applied to the mesh portion 32. As illustrated in FIGS. 5B and 5C, in a case where the pressure is not applied to the mesh portion 32, the mesh portion 32 blocks movement of a material between the inside and the outside of the mesh portion 32 by fibers intersecting with each other.

FIG. 5D is an enlarged view of a region indicated by a dotted line in FIG. 5A in a case where the pressure is applied to the mesh portion 32. FIG. 5E is a view illustrating the lower surface of the mesh portion 32 in a case where the pressure is applied to the mesh portion 32. As illustrated in FIGS. 5D and 5E, in a case where the pressure is applied, a hole portion 32a is formed by extension in the surface direction of the mesh portion 32 and contraction of the fibers in the direction orthogonal to the fibers that configure the mesh portion 32. As a result, similarly to each of the above-described embodiments, a part of the adhesive portion 11 protrudes from the hole portion 32a and the trash is adsorbed.

### Effect of Cleaning Tool 3

In the above-described cleaning tool 1, the hole portion 12a is formed in the film portion 12 in advance. Accordingly, when the pressure is applied, stress concentration occurs in the hole portion 12a, and there is a possibility that the strength of the film portion 12 deteriorates. This point is also similar to the above-described cleaning tool 2.

Meanwhile, in the cleaning tool 3 of the embodiment, in the mesh portion 32, the hole portion 32a is formed by extension in the surface direction of the mesh portion 32 and the above-described contraction of the fibers. Therefore, since stress is generated in the longitudinal direction of the fibers when the pressure is applied, the stress concentration is unlikely to occur in the hole portion 32a. Therefore, according to the mesh portion 32, compared to the above-described film portions 12 and 22, it is possible to further improve the strength of the film portion.

### Embodiment 4

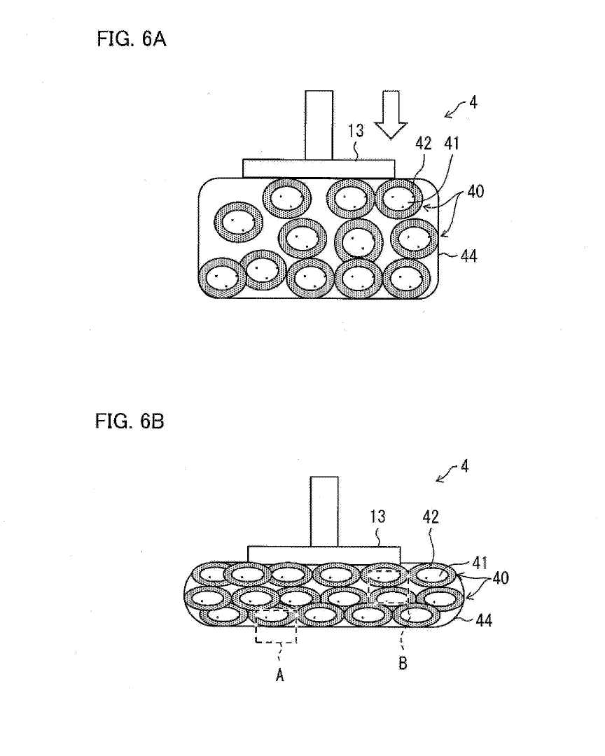

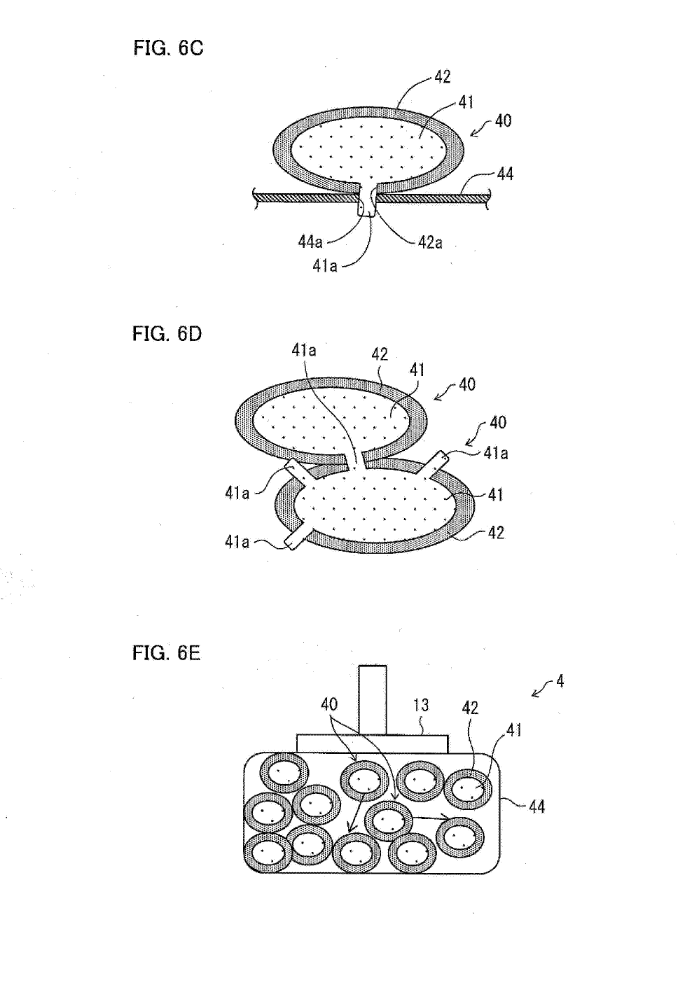

Embodiment 4 of the disclosure will be described based on FIGS. 6A to 6E, and is as follows.

### Configuration of Cleaning Tool 4

FIG. 6A is a sectional view illustrating a configuration of a cleaning tool 4 of the embodiment. As illustrated in FIG. 6A, the cleaning tool 4 includes the pressure applying portion 13, a plurality of cleaning members 40, and a mesh portion 44 (a second film, a film portion). In addition, each of the cleaning members 40 includes an adhesive portion 41 and a film portion 42 (also referred to as a first film).

In the cleaning members 40, the adhesive portions 41 are respectively included in the film portions 42. The film portion 42 includes one or more adhesive portions 41. A material of the adhesive portion 41 is similar to the above-described material of the adhesive portion 11. In addition, a material of the film portion 42 is similar to the above-described material of the film portion 12 (or the film portion 22).

In this manner, the cleaning member 40 has a configuration which is substantially similar to that of the above-described cleaning tool 1 (or the cleaning tool 2) excluding the pressure applying portion 13. A hole portion which is formed in the film portion 42 of the cleaning member 40 is referred to as a hole portion 42a. Meanwhile, a hole portion which is formed in the mesh portion 44 is referred to as a hole portion 44a (second hole portion).

The mesh portion 44 includes the plurality of cleaning members 40. In other words, the mesh portion 44 includes the plurality of film portions 42 including the adhesive portion 41. A material and a structure of the mesh portion 44 are similar to the above-described material and the structure of the mesh portion 32. In addition, instead of the mesh portion 44, a film portion having a configuration similar to that of the above-described film portion 12 or the film portion 22 may be used as a second film.

### Operation of Cleaning Tool 4

FIG. 6B is a view illustrating the cleaning tool 4 in a state where the pressure is applied to the mesh portion 44. FIG. 6C is an enlarged view of a region A indicated by a broken line in FIG. 6B. FIG. 6D is an enlarged view of a region B indicated by a broken line in FIG. 6B.

When the pressure is applied in the direction indicated by a white arrow with the pressure applying portion 13 to the cleaning tool 4 which is in a state illustrated in FIG. 6A, as illustrated in FIG. 6B, the mesh portion 44 and the plurality of cleaning members 40 included in the mesh portion 44 are deformed. At this time, as described above, the hole portion 42a expands in the film portion 42, and the hole portion 44a is formed in the mesh portion 44.

At this time, as illustrated in FIG. 6C, a part of the adhesive portion 41 which is adjacent to the surface to be cleaned 100 (not illustrated in FIGS. 6A to 6E) with the mesh portion 44 and the film portion 42 in between protrudes to the outside of the mesh portion 44 through the hole portion 42a and the hole portion 44a. In this manner, at least one of the plurality of adhesive portions 41 is exposed to the outside of the mesh portion 44 via the hole portion 42a and the hole portion 44a. Hereinafter, a protruding portion in the adhesive portion 41 is referred to as a protruding portion 41a. Trash on the surface to be cleaned 100 is adsorbed by the protruding portion 41a.

In addition, as illustrated in FIG. 6D, a part of the adhesive portion 41 which is not adjacent to the surface to be cleaned 100 with the mesh portion 44 and the film portion 42 in between also protrudes to the outside of the film portion 42 via the hole portion 42a. As a result, the protruding portion 41a is also formed inside of the mesh portion 44.

Therefore, inside of the mesh portion 44, a part of the protruding portion 41a formed in one cleaning member 40 (adhesive portion 41) can be brought into contact with the protruding portion 41a of another cleaning member 40 (adhesive portion 41). Therefore, one cleaning member 40 can pass the adsorbed trash to another cleaning member 40. In other words, it is possible to exchange trash between the cleaning members 40.

FIG. 6E is a view illustrating movement of the cleaning member 40 (adhesive portion 41) inside of the mesh portion 44. As illustrated in FIG. 6E, inside of the mesh portion 44, the plurality of cleaning members 40 are not densely disposed, and a space (cavity) in which the cleaning member 40 is movable is provided.

Therefore, inside of the mesh portion 44, by mixing the plurality of cleaning members 40 with each other, for example, it is possible to move the cleaning member 40 (adhesive portion 41) which has already adsorbed the trash to a position separated from the surface to be cleaned 100. In addition, it is also possible to move the adhesive portion 41 which has not adsorbed the trash to the position adjacent to the surface to be cleaned 100.

### Effect of Cleaning Tool 4

In the above-described cleaning tools 1 to 3, the trash is adsorbed only to a part of the adhesive portion which is positioned in the vicinity of the film portion (or the mesh portion). Meanwhile, the cleaning tool 4 of the embodiment includes the plurality of cleaning members 40 (adhesive portions 41) as described above.

Therefore, it is possible to adsorb the trash to at least one of the plurality of cleaning members 40 (the cleaning member 40 positioned in the vicinity of the mesh portion 44). In addition, it is possible to exchange the trash adsorbed by the cleaning member 40 with another cleaning member 40. Additionally, it is possible to move the cleaning member 40 which has already adsorbed the trash to the inside of the cleaning tool 4.

In addition, since the space in which the cleaning member 40 is movable is provided inside of the mesh portion 44, by moving the cleaning member 40 which has already adsorbed the trash to the inside of the cleaning tool 4, it is possible to move the trash to the inside of the cleaning tool 4. As a result, since the cleaning member 40 which is positioned inside of the cleaning tool 4 further contributes to cleaning the trash, it is possible to increase an amount of trash that can be collected by the cleaning tool 4.

In this embodiment, in the cleaning member 40, a configuration in which the plurality of adhesive portions 41 are respectively included in (covered with) the film portions 42. However, in the cleaning tool 4, the plurality of adhesive portions 41 are not included in the film portions 42, and may be directly included in the mesh portion 44.

### Embodiment 5

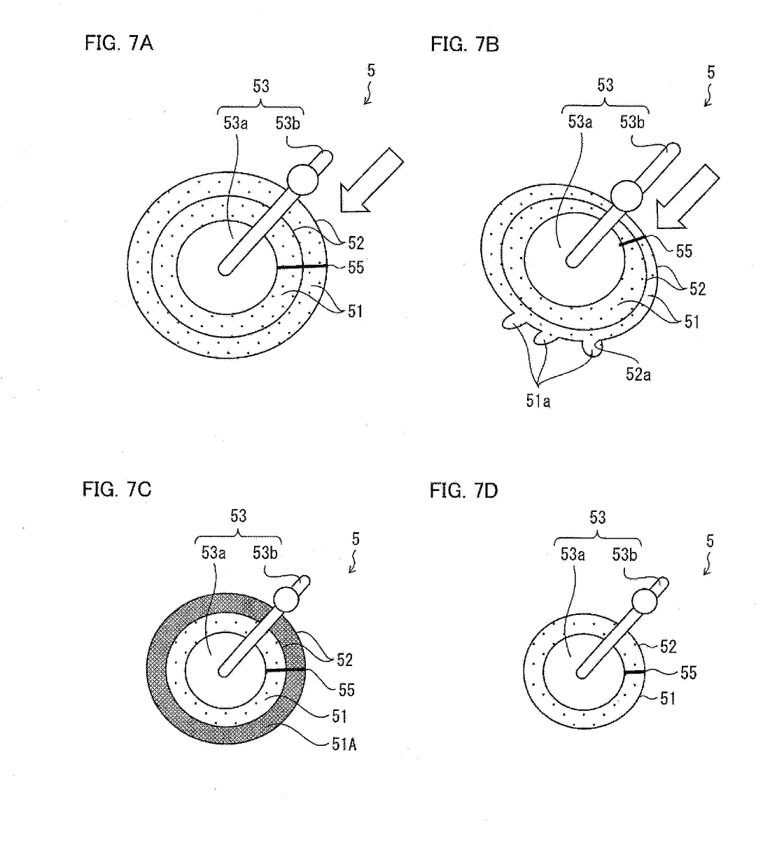

Embodiment 5 of the disclosure will be described based on FIGS. 7A to 7D, and is as follows. FIG. 7A is a side view illustrating a configuration of a cleaning tool 5 according to the embodiment. The cleaning tool 5 includes a plurality of adhesive portions 51, a plurality of film portions 52, a pressure applying portion 53, and an isolation film 55.

The cleaning tool 5 has a structure in which the plurality of adhesive portions 51 and the film portion 52 are laminated. In other words, the plurality of film portions 52 including the adhesive portion 51 have a layered structure. Materials of the adhesive portion 51 and the film portion 52 are respectively similar to the above-described materials of the adhesive portion 11 and the film portion 12. In addition, a hole portion formed in the film portion 52 is referred to as a hole portion 52a.

As described above, the respective adhesive portions 51 and the respective film portions 52 have a layered structure. Specifically, the adhesive portions 51 and the film portions 52 form a plurality of cylindrical (rolled) layers around a rotation portion 53a (which will be described later) of the pressure applying portion 53. In order to suppress adsorption between one end and the other end of the adhesive portion 51 in the circumferential direction of the rotation portion 53a, the isolation film 55 is provided between the one end and the other end.

The pressure applying portion 53 is a member for applying the pressure to the plurality of adhesive portions 51 and the plurality of film portions 52. The pressure applying portion 53 is provided with the rotation portion 53a and a gripping portion 53b. The rotation portion 53a is a cylindrical member, and layers of the plurality of adhesive portions 51 and the film portion 52 are formed on the side surface thereof. The gripping portion 53b is a part which is gripped by the user and is a part for applying the pressure to the film portion 52 via the rotation portion 53a. The rotation portion 53a is connected rotatably to the gripping portion 53b around a shaft of the rotation portion 53a. The pressure applied by the gripping portion 53b is applied to the adhesive portion 51 and the film portion 52 via the rotation portion 53a.

FIG. 7B is a view illustrating the cleaning tool 5 in a state where the pressure is applied to the film portion 52. In the film portion 52 to which the pressure is applied by the pressure applying portion 53, similarly to the film portion 12 or the like, the hole portion 52a expands. As illustrated in FIG. 7B, the adhesive portion 51 protrudes from the expanded hole portion 52a, and a protruding portion 51a is formed. Therefore, it is possible to adsorb trash on the surface to be cleaned, by the protruding portion 51a.

FIG. 7C is a view illustrating a state of the cleaning tool 5 after the cleaning tool 5 is used in cleaning. FIG. 7D is a view illustrating a state where the adhesive portion 51 (the adhesive portion which has already been used 51A that will be described hereinafter) of the outermost layer is removed from the cleaning tool 5 illustrated in FIG. 7C.

When performing the cleaning by using the cleaning tool 5, the adhesive portion 51 which is positioned on the outermost layer of the cleaning tool 5 adsorbs the trash, and as illustrated in FIG. 7C, the adhesive portion becomes the adhesive portion which has already been used 51A. Efficiency of adsorbing the trash of the adhesive portion which has already been used 51A is lower than that of the adhesive portion 51 which has not yet adsorbed the trash. Therefore, continuation of cleaning work by the cleaning tool 5 having the adhesive portion which has already been used 51A on the outermost layer causes deterioration of the work efficiency.

In this case, in the cleaning tool 5, using the isolation film 55 as a start point, it is possible to remove (peel) (i) the adhesive portion which has already been used 51A and (ii) the film portion 52 that covers (includes) the adhesive portion which has already been used 51A. By removing the adhesive portion which has already been used 51A and the film portion 52, as illustrated in FIG. 7D, the adhesive portion 51 inside of the adhesive portion which has already been used 51A is newly positioned on an outermost layer, and the trash can be adsorbed by the adhesive portion 51.

Similarly to the above-described cleaning tool 1 or the like, the cleaning tool 5 of the embodiment also becomes a cleaning tool which is excellent in sanitation. In particular, in the cleaning tool 5, it is possible to easily remove the adhesive portion 51 on the outermost layer on which the trash is accumulated, and to perform cleaning by using the adhesive portion 51 which is positioned inside with respect to the outermost layer. Therefore, similarly to the above-described cleaning tool 4, since the adhesive portion 51 positioned inside contributes to cleaning, it is possible to increase the amount of trash that can be collected.

In this embodiment, in the cleaning tool 5, a configuration in which each of the adhesive portion 51 and the film portion 52 forms a cylindrical layer on the side surface of the rotation portion 53a is illustrated as an example. However, each of the adhesive portion 51 and the film portion 52 may individually configure, for example, a plurality of spherical or plane-like layers.

### Embodiment 6

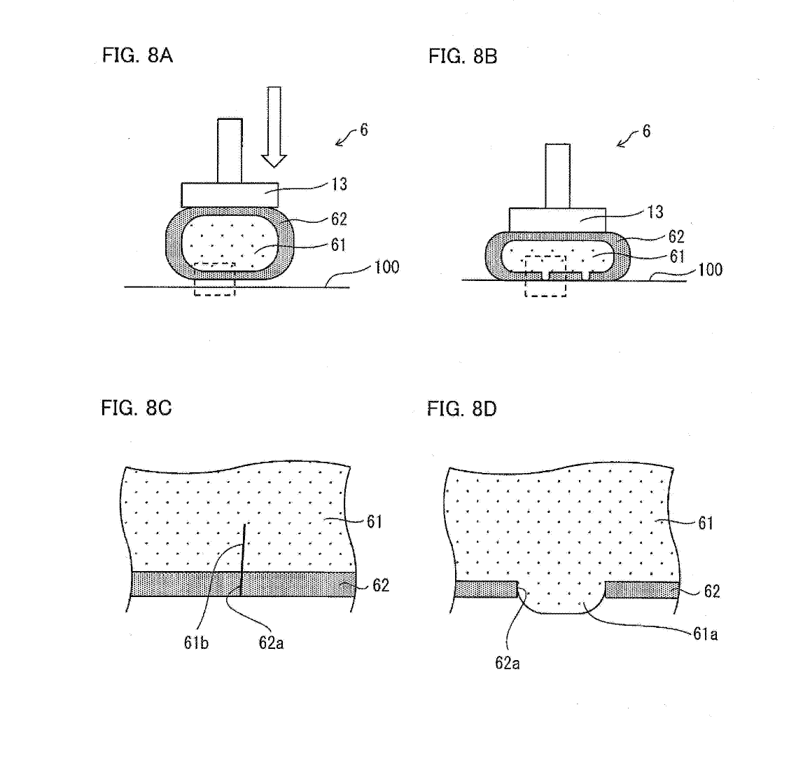

Embodiment 6 of the disclosure will be described based on FIGS. 8A to 8D, and is as follows. FIG. 8A is a sectional view illustrating a configuration of a cleaning tool 6 of the embodiment. The cleaning tool 6 includes an adhesive portion 61 and a film portion 62 instead of the adhesive portion 11 and the film portion 12 in the configuration of the cleaning tool 1.

Materials of the adhesive portion 61 and the film portion 62 are similar to the above-described materials of the adhesive portion 11 and the film portion 12. However, Young's modulus of the film portion 62 is set to be higher than that of the adhesive portion 61. In other words, the film portion 62 is unlikely to be deformed compared to the adhesive portion 61 (elasticity is high). In addition, the film portion 62 is physically or chemically combined to the adhesive portion 61. Therefore, a positional relationship does not change relatively between the adhesive portion 61 and the film portion 62.

In the film portion 62, a slit 62a is formed. In addition, a slit 61b is formed in the adhesive portion 61 at a position which matches the slit 62a (position which is continuous to the slit 62a).

Next, an operation of the cleaning tool 6 will be described further with reference to FIGS. 8B to 8D. FIG. 8B is a sectional view illustrating a state where the pressure is applied to the film portion 62. FIG. 8C is an enlarged view of a region surrounded by a dotted line in FIG. 8A. FIG. 8D is an enlarged view of a region surrounded by a dotted line in FIG. 8B.

In the cleaning tool 6 in a state illustrated in FIGS. 8A and 8C, the pressure with a degree in the range of the adhesive portion 61 and the film portion 62 being elastically deformed is applied by the pressure applying portion 13 in the direction indicated by a white arrow in FIG. 8A.

In addition, as illustrated in FIGS. 8B and 8D, the adhesive portion 61 and the film portion 62 are deformed by the applied pressure. At this time, each of the adhesive portion 61 and the film portion 62 is deformed about the slit 62a and the slit 61b as a center.

Specifically, the slit 62a is enlarged (open), and a region inside of the slit 61b is exposed to the outside of the film portion 62 via the slit 62a, and a protruding portion 61a is formed. Since the protruding portion 61a comes into contact with trash on the surface to be cleaned 100, the trash is adsorbed to the protruding portion 61a. By deepening the slit 61b and the slit 62a, not only the surface of the adhesive portion 61 but also the inside thereof may be exposed.

Similarly to the above-described cleaning tool 1 or the like, the cleaning tool 6 of this embodiment also becomes a cleaning tool which is excellent in sanitation. In particular, in the cleaning tool 6, not only the surface of the adhesive portion 61 but also the region inside can be exposed to the outside of the film portion 62. Since the region of the inside of the adhesive portion 61 is exposed, an area of the region of the adhesive portion 61 which can be used for adsorbing the trash increases. Therefore, it is possible to increase the amount of trash that can be adsorbed by the adhesive portion 61.

### Embodiment 7

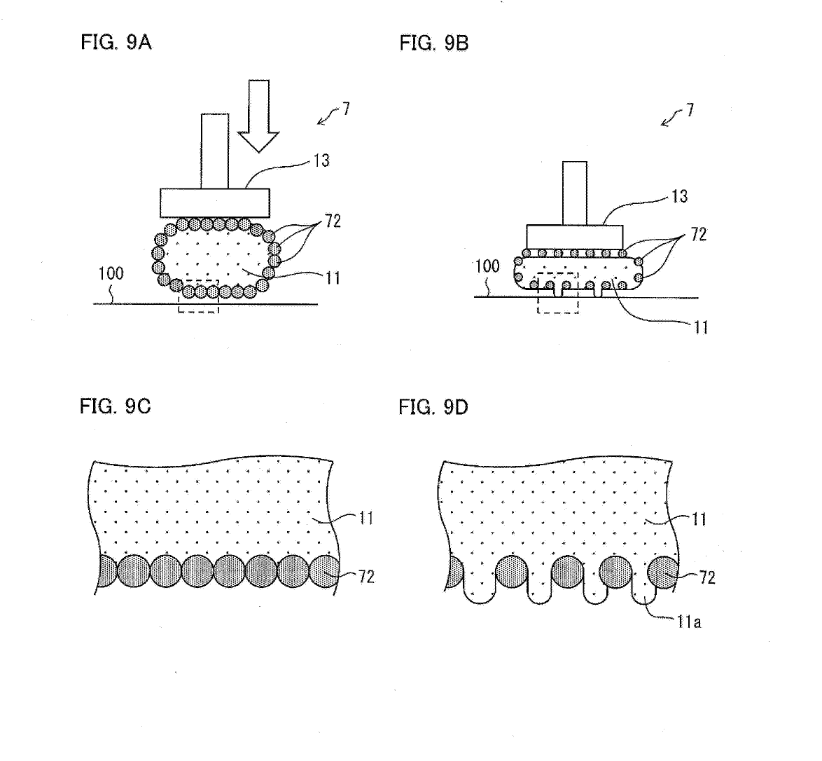

Embodiment 7 of the disclosure will be described based on FIGS. 9A to 9D, and is as follows. FIG. 9A is a sectional view illustrating a configuration of a cleaning tool 7 of the embodiment. The cleaning tool 7 includes a coating material 72 instead of the film portion 12 in the configuration of the cleaning tool 1.

The coating material 72 is a particle-like member which forms a coating that covers the adhesive portion 11. The coating material 72 is adsorbed to the adhesive portion 11. As the coating material 72, it is possible to use a general polymer material, such as a silicone resin or a fluorocarbon resin. The coating material 72 may have a shape of, for example, a spherical, cylindrical, or rectangular parallelepiped (rectangular) shape.

The coating material 72 is formed by a method, such as coating by spraying, dip coating, evaporating, or sputtering. The coating material 72 is physically or chemically combined with the adhesive portion 11. Meanwhile, particles of the coating material 72 do not combined with each other.

FIG. 9B is a sectional view illustrating a state where the pressure is applied to the coating material 72. FIG. 9C is an enlarged view of a region surrounded by a dotted line in FIG. 9A. FIG. 9D is an enlarged view of a region surrounded by a dotted line in FIG. 9B.

When the downward pressure is applied as indicated by a white arrow with the pressure applying portion 13 to the cleaning tool 7 in a state illustrated in FIGS. 9A and 9C, the adhesive portion 11 and the coating material 72 are deformed as illustrated in FIGS. 9B and 9D.

Here, since particles of the coating material 72 are not combined with each other, an adsorbing force does not act. Therefore, the shape of the adhesive portion 11 included in the coating material 72 is changed by the pressure, and the protruding portion 11a is formed outside through the space between particles of the coating material 72. In this manner, in the cleaning tool 7, a void between particles of the coating material 72 functions as a hole portion. Accordingly, similarly to the above-described Embodiment 1 or the like, the trash is adsorbed by the protruding portion 11a.

Similarly to the above-described cleaning tool 1 or the like, the cleaning tool 7 of this embodiment becomes a cleaning tool which is excellent in sanitation. In particular, in the cleaning tool 7, by reducing the size of the coating material 72 (for example, making the thickness of the coating material 72 approximately several tens of microns to several mm), it is possible to efficiently adsorb the trash to the surface of the adhesive portion 11.

### Embodiment 8

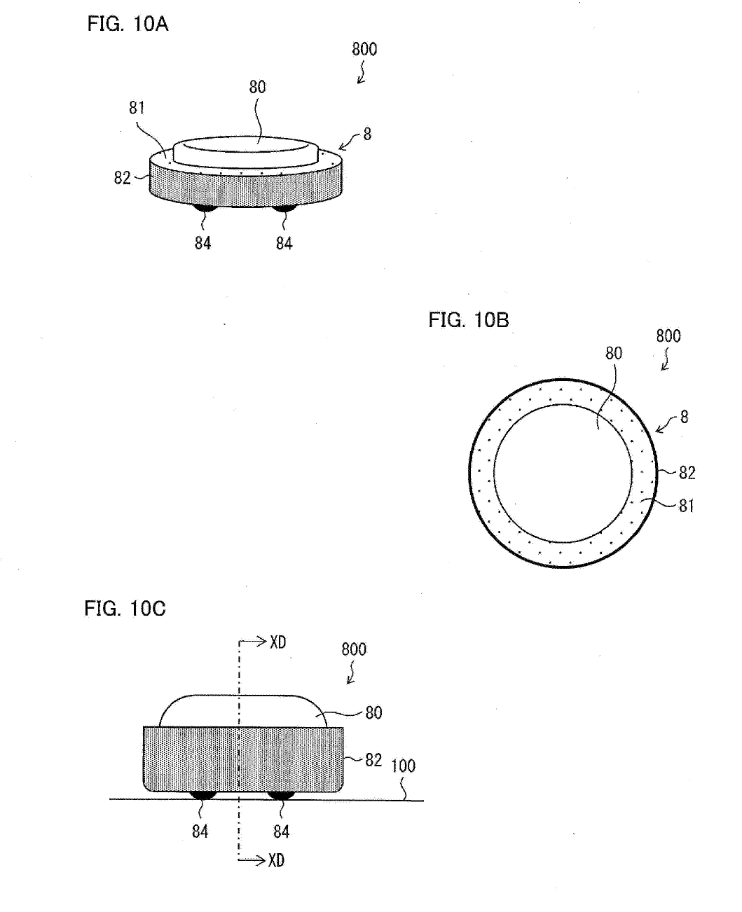

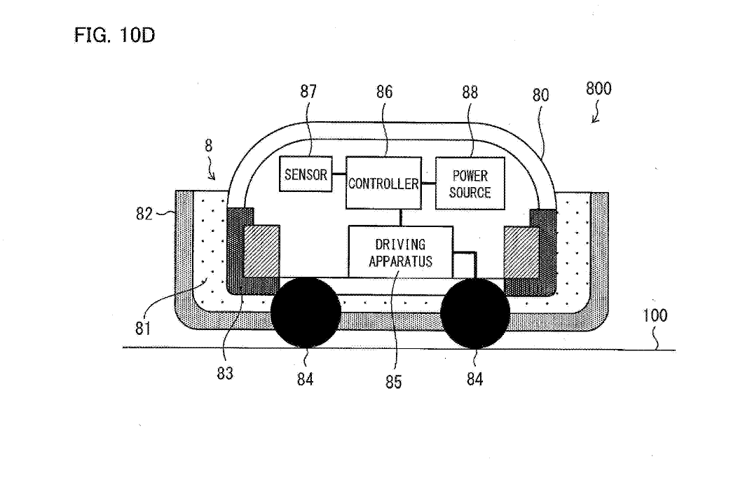

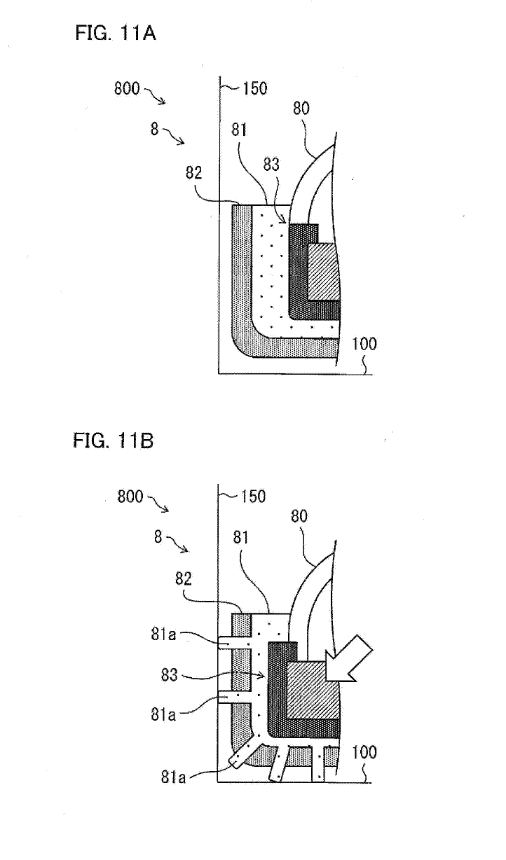

Embodiment 8 of the disclosure will be described based on FIGS. 10A to 10D and 11A and 11B, and is as follows. In the embodiment, a cleaning robot 800 provided with a cleaning tool according to one aspect of the disclosure will be described. In the embodiment, as the cleaning robot 800, a robot cleaner which can automatically travel (automatically move) on the surface to be cleaned 100 (a travel surface or a floor surface) will be described as an example.

FIGS. 10A to 10D are views illustrating a configuration of portions of the cleaning robot 800, FIG. 10A is a view schematically illustrating an appearance of the cleaning robot 800, FIG. 10B is a top view of the cleaning robot 800, FIG. 10C is a side view of the cleaning robot 800, and FIG. 10D is a sectional view taken along line XD-XD of FIG. 10C.

The cleaning robot 800 includes a cleaning tool 8, a cover 80, a pressure applying portion 83, a wheel portion 84, a driving apparatus 85, a controller 86, a sensor 87, and a power source 88. The cleaning tool 8 includes an adhesive portion 81, a film portion 82, a pressure applying portion 83.

Each of the adhesive portion 81 and the film portion 82 may be similar to the adhesive portion 11 and the film portion 12 of the above-described Embodiment 1. However, each of the adhesive portion and the film portion in each of the above-described embodiments and the modification example other than Embodiment 1 can also be used as the adhesive portion 81 and the film portion 82. In addition, the pressure applying portion 83 is similar to the above-described pressure applying portion 13 or the like except for the point that the operation is controlled by the controller 86.

The cover 80 is a protection member which covers the driving apparatus 85, the controller 86, the sensor 87, and the power source 88. In addition, the cover 80 also functions as a supporting member which supports each member of the cleaning robot 800. The adhesive portion 81 and the film portion 82 are disposed on an outer side of the cover 80.

The controller 86 integrally controls operations of each member of the cleaning robot 800. The power source 88 supplies the power source for operating each member of the cleaning robot 800 to each member. The sensor 87 is a sensor (proximity sensor) which detects proximity of a target, and for example, may be an infrared sensor.

The detection result (proximity detection result) of the sensor 87 is used as a signal indicating whether or not an obstacle exists in the proximity of the cleaning robot 800. In addition, the obstacle may be, for example, a wall surface 150 which will be described later, or may be a step in the surface to be cleaned 100.

The wheel portion 84 is a member which is provided for performing automatic travel on the surface to be cleaned 100 in the cleaning robot 800. The driving apparatus 85 is a member which drives the wheel portion 84, and for example, may be configured of a driving mechanism, such as a motor. The wheel portion 84 and the driving apparatus 85 may be integrally referred to as a travelling unit. As the cleaning robot 800 automatically travels on the surface to be cleaned 100, it is possible to automatically clean the surface to be cleaned 100 by the cleaning tool 8.

The controller 86 may control the driving apparatus 85 based on the detection result of the sensor 87. For example, in a case where the cleaning robot 800 is in the proximity of the obstacle, the controller 86 may control the driving apparatus 85, and may set (change) the travelling direction of the cleaning robot 800 so that the cleaning robot 800 avoids the obstacle.

In addition, the controller 86 may control the driving apparatus 85, and set (change) the travelling speed of the cleaning robot 800 based on the detection result of the sensor 87. For example, in a case where the cleaning robot 800 is in the proximity of the obstacle, the controller 86 may reduce the travelling speed of the cleaning robot 800.

FIGS. 11A and 11B are sectional views illustrating an example of cleaning by the cleaning robot 800, FIG. 11A is a view illustrating a state before the pressure is applied to the cleaning tool 8, and FIG. 11B is a view illustrating a state after the pressure is applied to the cleaning tool 8. In addition, in FIGS. 11A and 11B, for making it simple, only a part of the member which is positioned in the proximity of the cleaning tool 8 is illustrated.

Here, a surface linked to the surface to be cleaned 100, that is, a surface which is not parallel to the surface to be cleaned 100, is referred to as the wall surface 150. In FIGS. 11A and 11B, a case where the wall surface 150 is a surface vertical to the surface to be cleaned 100 is illustrated as an example. Hereinafter, the direction parallel to the wall surface 150 is referred to as the longitudinal direction. As illustrated in FIGS. 11A and 11B (and FIGS. 10A to 10D described above), the adhesive portion 81 and the film portion 82 are also provided in the longitudinal direction in the vicinity of an outer edge portion of the cleaning robot 800.

As illustrated in FIG. 11B, in a case where the pressure is applied to the cleaning tool 8, a part of the adhesive portion 81 protrudes from the hole portion of the film portion 82, and forms the plurality of protruding portions 81a. As a result, a part of a protruding portion 81a (protruding portion 81a which protrudes toward the surface to be cleaned 100) comes into contact with trash on the surface to be cleaned 100, and adsorbs the trash.

In addition, a part of the protruding portion 81a (protruding portion 81a which protrudes toward the wall surface 150) comes into contact with trash on the wall surface 150, and adsorbs the trash. In this manner, by positioning the cleaning robot 800 in the proximity of the wall surface 150, in addition to the surface to be cleaned 100, the wall surface 150 can also be cleaned.

In addition, by providing the adhesive portion 81 and the film portion 82 in the vicinity of the outer edge portion of the cleaning robot 800, a direct contact of other members (in particular, the driving apparatus 85, the controller 86, the sensor 87, and the power source 88) of the cleaning robot 800 with the obstacle can be suppressed. In other words, the adhesive portion 81 and the film portion 82 can be used as a buffering material (cushion) of the cleaning robot 800. Accordingly, in a case where the cleaning robot 800 comes into contact with (collides with) the obstacle during the travel, it is also possible to suppress damage of each member of the obstacle and the cleaning robot 800.

As described above, the cleaning tool according to one aspect of the disclosure may be provided in a cleaning robot. However, a configuration of the cleaning robot according to one aspect of the disclosure is not limited only to the above-described configuration of the cleaning robot 800. For example, the cleaning tool according to one aspect of the disclosure may be provided in a sole of a human type robot or an animal type robot which can automatically travel (automatically move) on the surface to be cleaned 100.

In this manner, the cleaning robot according to one aspect of the disclosure may be configured to be capable of cleaning the surface to be cleaned 100 by the cleaning tool by automatically moving on the surface to be cleaned 100.

### Summary

A cleaning tool (1) according to Aspect 1 of the disclosure includes: an adhesive portion (11) that adsorbs an object to be adsorbed (trash 200); and a film portion (12) that includes the adhesive portion, the film portion includes a hole portion (12a) which expands in accordance with an external force applied to the film portion, and the adhesive portion is exposed to the outside of the film portion via the hole portion in a case where the external force equal to or greater than a predetermined magnitude is applied to the film portion.

According to the configuration, in the cleaning tool, in a case where the external force equal to or greater than a predetermined magnitude is applied to the film portion, the adhesive portion is exposed to the outside of the film portion from the hole portion. The object to be adsorbed is adsorbed by the adhesive portion exposed to the outside.

Therefore, by applying the pressure to the film portion, the user can perform the cleaning by exposing the adhesive portion to the outside of the film portion and by adsorbing the object to be adsorbed by the adhesive portion. After finishing the cleaning, by reducing the pressure, the adhesive portion can be accommodated in the film portion together with the object to be adsorbed which is adsorbed to the adhesive portion. Therefore, since the adsorbed object is not exposed to the outside of the film portion after finishing the cleaning, an effect that a cleaning tool which is more excellent in sanitation than that of the related art can be realized is achieved.

In the cleaning tool according to Aspect 2 of the disclosure, in the above-described Aspect 1, the film portion may have auxetic properties.

According to the configuration, since the film portion contracts in a case where the external force is applied, the opening area of the hole portion becomes greater. Therefore, an effect that the cleaning can be more efficiently performed is achieved.

In the cleaning tool according to Aspect 3 of the disclosure, in the above-described Aspect 1 or 2, the film portion may have a mesh-like structure.

According to the configuration, since stress is generated in the longitudinal direction of the fiber in the mesh-like structure when the pressure is applied to the film portion, stress concentration is unlikely to occur in the film portion. Therefore, an effect that the strength of the film portion can be improved is achieved.

In the cleaning tool according to Aspect 4 of the disclosure, in any one of the above-described Aspects 1 to 3, the film portion (mesh portion 44) may include a plurality of adhesive portions (41), and at least one of the plurality of adhesive portions may be exposed to the outside of the film portion via the hole portion in a case where the external force equal to or greater than a predetermined magnitude is applied to the film portion.

According to the configuration, by applying the pressure to the film portion, it is possible to adsorb the object to be adsorbed by at least one of the plurality of adhesive portions. In addition, inside of the film portion, it is possible to exchange the adsorbed object between adjacent adhesive portions. Therefore, by moving the adsorbed object to the inside of the cleaning tool, the adhesive portion positioned inside contributes to cleaning, and thus, an effect that the amount of the object to be adsorbed that can be collected may be increased is achieved.

In the cleaning tool according to Aspect 5 of the disclosure, in the above-described Aspect 4, the film portion may include a space in which a plurality of the adhesive portions are movable.

According to the configuration, for example, it is possible to move the adhesive portion positioned in the vicinity of the hole portion to the inside of the film portion. Therefore, following the movement of the adhesive portion, it is possible to move the object adsorbed to the adhesive portion to the inside of the cleaning tool. Therefore, an effect that the amount of the object to be adsorbed that can be collected may be increased is achieved.

The cleaning tool according to Aspect 6 of the disclosure, in any one of the above-described Aspects 1 to 3, may further include a second film (mesh portion 44) that includes a plurality of film portions (42) each of which includes the adhesive portion, the second film includes a second hole portion (hole portion 44a) which expands in accordance with the external force applied to the second film, and at least one of a plurality of adhesive portions may be exposed to the outside of the second film via the hole portion and the second hole portion in a case where the external force equal to or greater than a predetermined magnitude is applied to the second film.

According to the configuration, an effect similar to that of the cleaning tool according to the above-described Aspect 4 is achieved.

In the cleaning tool according to Aspect 7 of the disclosure, in any one of the above-described Aspects 1 to 3, a plurality of film portions (52) including the adhesive portion (51) may have a layered structure.

According to the configuration, after the object to be adsorbed is adsorbed by the adhesive portion of the uppermost layer, it is possible to remove the adhesive portion, and perform the cleaning by using the adhesive portion which is positioned on the inside. Therefore, the adhesive portion positioned on the inside in the cleaning tool contributes to cleaning, and thus, an effect that the amount of the object to be adsorbed that can be collected may be increased is achieved.

In the cleaning tool according to Aspect 8 of the disclosure, in the above-described Aspect 1 or 2, the hole portion may be a slit (62a) formed in the film portion, and a slit (61b) of the adhesive portion is formed at a position that matches the slit of the hole portion.

According to the configuration, by applying the pressure to the adhesive portion and the film portion, it is possible to expose the inside of the adhesive portion, and to adsorb the object to be adsorbed. Therefore, the area of the region which can be used in adsorbing the object to be adsorbed increases, and an effect that the amount of the object adsorbed can be increased is achieved.

In the cleaning tool according to Aspect 9 of the disclosure, in the above-described Aspect 1 or 2, the film portion may include a particle-like coating material (72) adsorbed to the adhesive portion. According to the configuration, for example, by reducing the size of the coating material, an effect that the object to be adsorbed can be more efficiently adsorbed to the surface of the adhesive portion is achieved.

A cleaning robot (800) according to Aspect 10 of the disclosure includes: the cleaning tool according to any one of the above-described Aspects 1 to 9.

According to the configuration, an effect which is similar to that of the cleaning tool according to one aspect of the disclosure is achieved.

### Supplementary Information

The disclosure is not limited to each of the above-described embodiments, various changes are possible within a range illustrated in the claims, and embodiments which can be obtained by appropriately combining the technical measures that are respectively disclosed in various embodiments are included in the technical range of the disclosure. Furthermore, by combining the technical measures that are respectively disclosed in each of the embodiments, it is possible for new technical characteristics.

The present disclosure contains subject matter related to that disclosed in Japanese Priority Patent Application JP 2016-079868 filed in the Japan Patent Office on Apr. 12, 2016, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A cleaning tool comprising:
at least one adhesive portion that adsorbs an object to be adsorbed; and
at least one film portion that includes the adhesive portion, wherein
the film portion includes a hole portion which expands in accordance with an external force applied to the film portion, and
the adhesive portion is exposed to the outside of the film portion via the hole portion in a case where an external force equal to or greater than a predetermined magnitude is applied to the film portion.

2. The cleaning tool according to claim 1, wherein
the film portion has auxetic properties.

3. The cleaning tool according to claim 1, wherein
the film portion has a mesh-like structure.

4. The cleaning tool according to claim 1, wherein
the at least one adhesive portion includes a plurality of adhesive portions, the film portion including the adhesive portions, and
at least one of the adhesive portions is exposed to the outside of the film portion via the hole portion in a case where the external force equal to or greater than a predetermined magnitude is applied to the film portion.

5. The cleaning tool according to claim 4, wherein
the film portion includes a space in which a plurality of the adhesive portions are movable.

6. The cleaning tool according to claim 1, further comprising
a second film that includes a plurality of film portions each of which is the film portion including the adhesive portion, wherein
the second film includes a second hole portion which expands in accordance with the external force applied to the second film, and
at least one of a plurality of adhesive portions each of which is the adhesive portion is exposed to the outside of the second film via the hole portion and the second hole portion in a case where the external force equal to or greater than a predetermined magnitude is applied to the second film.

7. The cleaning tool according to claim 1, wherein
a plurality of film portions each of which is the film portion including the adhesive portion have a layered structure.

8. The cleaning tool according to claim 1, wherein
the hole portion is a slit formed in the film portion, and
the adhesive portion has a slit formed at a position that matches the slit of the hole portion.

9. The cleaning tool according to claim 1, wherein
the film portion includes a particle-like coating material adsorbed to the adhesive portion.

10. A cleaning robot comprising:
the cleaning tool according to claim 1.
